(19) United States
(12) Patent Application Publication
(10) Pub. No.: US 2021/0199167 A1
(43) Pub. Date: Jul. 1, 2021

(54) DISC BRAKE

(71) Applicants: FAGOR EDERLAN S. COOP, 20540 Eskoriatza, Gipuzkoa (ES); FORD-WERKE GMBH, Köln (DE)

(72) Inventors: THOMAS WILWERS, Köln (DE); CLEMENS VERPOORT, Monheim r. Rhein (DE); MARC OLIVER RETTIG, Köln (DE); TOMASZ GRABIEC, Bergisch Gladbach (DE); IDURRE GAZTANAGA GALLASTEGI, Guipuzcoa (ES); RICARDO LABRADOR VAREA, Vizcaya (ES); INAKI LANDA SASTRE, Legazpi (ES); MARIA EDURNE OCHOA DE ZABALEGUI PEREDA, Gasteiz (ES); INAKI ZUBELDIA BARRON, Guipuzcoa (ES)

(73) Assignee: FAGOR EDERLAN S.COOP, 20540 Eskoriatza, Gipuzkoa (ES)

(21) Appl. No.: 16/650,736

(22) PCT Filed: Sep. 19, 2018
(86) PCT No.: PCT/DE2018/000264

§ 371 Date: Mar. 25, 2020

(30) Foreign Application Priority Data
Sep. 26, 2017 (DE) 10 2017 008 992.2

(51) Int. Cl. F16D 65/12

(52) U.S. Cl. CPC F16D 65/125; F16D 2065/1308

(57) ABSTRACT

A disc brake includes a brake disc made of light metal and a brake pad. The brake disc includes a brake track having formed therein a plurality of depressions which are distributed over a surface of the brake track. The brake disc is formed from a hypereutectic aluminum silicon alloy, which has a silicon content of 13 to 21 wt. % and a maximum content of 0.3 wt. % of copper. The brake pad is configured to act on the brake disc and includes a NAO friction material.

The invention relates to a disc brake with the features of the preamble of claim 1, including a brake disc made of light metal and at least one brake pad acting on it, wherein the brake disc has on at least one of its brake tracks a plurality of depressions, preferably of grooves, which are distributed over the surface of the brake track, preferably distributed over the entire surface of the brake track.

In vehicles, in particular motor vehicles, disc brakes form arguably the most widespread type of brake systems. Disc brakes essentially are comprised of a brake disc and a brake caliper encompassing the brake disc on the edge. The brake disc is hereby connected to the wheel of the vehicle to be braked via a wheel hub which is rotatably mounted in the steering knuckle. Conversely, the brake caliper is fixed to the steering knuckle. The actual deceleration is realized by brake pads which can be applied on the brake disc and which are arranged on both sides of the brake disc between the brake disc and the brake caliper.

Depending on the application, brake discs can be made of iron but also of carbon ceramic or aluminum. Brake discs made of iron, more precisely gray cast iron, are fairly widespread, but exhibit the known problem of surface rust on surface areas that are not covered by brake pads. This surface rust is unsightly and creates the visual impression of poor quality. Frictional properties of the corrosively attacked surface areas are also different in relation to the non-corrosively attacked surface areas, causing the undesirable “brake rubbing”. Annoying noises (NVH) may also occur. In addition, there is sometimes a damaging effect in combination with aluminum rims, on the surface of which the hot iron particles that become loosened during the braking process can literally burn themselves in. It is known that around 50-70% of the total fine brake dust is due to wear of the brake discs of iron.

Overall, brake discs should have a brake surface that is as wear-resistant as possible and releases little fine dust. In order to achieve this, a hardest possible surface configuration is sought. Brake discs made of aluminum have to be able to cope with high, complex and interactive requirements. Factors such as e.g. strength, corrosion resistance, stable generation of friction under common operating conditions for vehicles (salt, cold, heat, wet, moisture, etc.) with simultaneous wear resistance play a role. Aluminum by itself is not suitable for this purpose, so that aluminum-matrix composite alloys with embedded hard material particles are used. Silicon carbide (SiC), for example, is therefore added to brake discs made of aluminum to form a separate wear-resistant protective layer on the surface. However, the production of brake discs from non-ferrous materials is sometimes difficult and oftentimes cost-intensive, However, in the course of the desired CO2 reduction, efforts are made to save weight, which can be achieved by replacing iron with light metals. In addition, light metals cause a reduction of the unsprung and also rotating mass, thereby positively affecting handling of the motor vehicle and driving resistance.

DE 10 2011 121 292 A1 for example, describes a brake disc made of an aluminum matrix composite alloy, with the aluminum matrix composite alloy having a silicon carbide particle content of at least 40% by volume. During the complicated production, a layer enriched with silicon carbide particles and a layer correspondingly depleted with silicon carbide particles are produced. The layer depleted in silicon carbide particles is separated from the layer enriched with silicon carbide particles. For finishing the layer enriched with silicon carbide, provision is made for a 16 heat treatment, which includes solution annealing and artificial aging, The process for the production of the semi-finished brake disc with the desired very high amount of silicon carbide particles in the enriched layer is very complicated and very cost-intensive because of the very time-consuming process steps, in addition, a subsequent surface processing step, such as e.g. etching, becomes necessary, which further pollutes the environment.

The generic DE 20 2015 101 510 U1 is concerned with a vehicle disc brake, made of light metal, which has at least one of its brake tracks provided with a plurality of grooves which are distributed over the entire surface of the brake track. The light metal is alloyed aluminum.

The invention is based on the object to provide a disc brake which is improved in terms of wear resistance and corrosion resistance while yet enabling a simple production of the brake disc.

According to the invention, the object is attained by a disc brake with the features of claim 1, with the subclaims relating to advantageous configurations of the invention.

It should be noted that the features and measures referred to individually in the description hereinafter can be combined with one another in any technically meaningful manner and show further refinements of the invention. The description additionally characterizes and specifies the invention.

According to the invention, the brake disc is formed from a hypereutectic aluminum-silicon alloy which has a silicon content of 13 to 21 wt. % and a maximum content of 0.3 wt. % of copper, with the brake pad having NAO friction materials.

NAO friction materials (Non Asbestos Organic) are asbestos-free within the meaning of this invention, The NAO friction materials can contain copper or be free of copper. Of course, the brake pad may also have friction materials other than NAO.

The invention thus provides an improved disc brake which is comprised of brake disc and brake pad and in which the grooves arranged in the brake track increase the coefficient of friction and reduce wear. The wet braking behavior is also significantly improved.

Depressions are arranged on the brake track and can be configured as countersunk bores. Preferably, the depressions are configured as grooves.

Regarding the arrangement and configuration of the grooves on the at least one brake track or on both brake tracks, reference is made to DE 20 2015 101 510 U1, which in this respect is also part of the content of this invention in its entirety, also with respect to the FIGS. 1 to 3, including the description thereof,

The hypereutectic aluminum-silicon alloy of the brake disc has the components in a targeted configuration

13 to 21 wt. % of silicon, preferably 16 to 20 wt. % of silicon,
0.2 to 0.7 wt. % of magnesium,
maximum 0.001 wt. % of strontium,
maximum 0.2 wt. % of iron,
0.06 to 0.1 wt. % of titanium,
maximum 0.3 wt. % of copper, and
remainder aluminum.

As a result of the maximum content of 0.3 wt. % of copper, the brake disc is almost copper-free, with corrosion resistance being achieved by omitting copper. Due to the hypereutectic aluminum-silicon alloy, the corrosion resistance of the tribological system, i.e. the disc brake, is increased, while need for a subsequent, cost-intensive surface layer technology can be eliminated, The effect of the improved corrosion resistance can be further enhanced by the copper-free NAO friction material of the brake pads. The suitable hardness and strength of the brake disc even at high temperature ranges of e.g. 400° C. to 500° C., preferably from 400° C. to 450° C. is achieved by the high silicon content.

It is hereby ideal when the silicon particles are homogeneously distributed, wherein it is considered particularly beneficial when the silicon particles have a primary silicon particle size of 30 to 100 μm, preferably maximal 50 μm, more preferably 30 to 50 μm. Provision is suitably made for addition of AlCuP elements (aluminum-copper-phosphorus) to the ahoy in order to generate a content of 15 to 30 ppm of phosphorus, so that the grain refinement of the primary silicon and the homogeneous distribution is realized. The AlCuP elements are alloyed as rods such that the maximum copper content of 0.3 wt. % is maintained in the final hypereutectic aluminum-silicon alloy.

According to a known configuration, the brake disc has friction rings on which the brake tracks are arranged in opposition to one another. The brake hat connects to the friction rings and is used to fasten the brake disc to the wheel hub via bolts. Within the meaning of the invention, it is beneficial when the brake disc is produced completely in one piece, preferably cast. An example of a casting process involves the low pressure casting process (LPDC process=Low Pressure Die Cast). As the brake disc is fully cast in one piece, considerable cost savings are achieved since, apart from machining, no further treatments are required. The brake disc can be configured as a solid brake disc or as a ventilated brake disc. Of course, the brake disc can also be made in several parts, i.e. in two parts (brake hat, friction ring).

Instead of the LPDC process, the brake disc could also be produced with other casting processes, such as e.g. gravity die casting (GDC) or other casting processes. However, the low-pressure casting process is appropriate, since its feed device enables the casting mold to be filled homogeneously and, due to heating and insulation, to have an advantageous heat balance, so that best solidification conditions are realized. This results in the desired microstructure and in a reduced microporosity of the hypereutectic aluminum-silicon alloy. Using the procedure according to the invention, a hardness variation of less than 14 HB (Brinell hardness) is achieved on the brake track. The hardness of the brake track immediately results directly in its abrasion resistance, with the wear behavior depending on the hardness of the surface of the brake track. The hardness and homogeneity of the brake track is decisive for the formation of a suitable transfer film between the friction material of the brake pad and the brake disc, whereby the depressions arranged on the brake track in the preferred configuration and designed here as furrows or grooves are just as effective. The necessary hardness and homogeneity of the brake track is realized by the particular low-pressure casting process with the heated and insulated casting mold. Of course, the properties, i.e. also the homogeneous distribution of the silicon particles are not only realized on the brake track, but may also be found in the entire brake disc due to the single-piece production of the brake disc.

Although the brake disc made of the almost copper-free, hypereutectic aluminum-silicon alloy does not require any further post-processing (apart from the optional machining process), provision may still be made for a hard anodizing or laser oxidation, by which a further improvement in the corrosion resistance can be achieved and the wear behavior of the brake disc but also of the brake pad can be improved.

The brake disc is preferably produced with at least the following steps: producing a hypereutectic aluminum-silicon alloy with a high silicon content, then grain refining of the primary silicon using a 15 to 30 ppm proportion of phosphorus, then low-pressure casting, so that a homogeneous microstructure and low microporosity is achieved, with the production process being directly dependent on casting parameters such as e.g. casting temperature and cooling measures.

The preferred low-pressure casting allows a filling from the hub side of the brake disc and enables 360° filling. This is particularly appropriate in so far as the homogeneous distribution of the silicon particles in the entire brake disc, i.e. not only in the area of the brake track, is realized. The casting temperature of the alloy should be in the range of 700° C. to 800° C., so that the required and desired properties of the brake disc can be achieved. Deviations of ±10% from the mentioned casting temperature are possible. Provision is suitably made for an air cooling both in an upper region and in a lower region of the casting mold, so as to cool the brake disc from the inside, which is also useful with ventilated brake discs. In conjunction with a liquid cooling cassette system, which is arranged on the filling system of the casting mold, the required and desired properties of the brake disc are achieved.

To date, almost copper-free, hypereutectic aluminum-silicon alloys were never used for the production of brake discs, which are engaged by copper-free or copper-containing NAO friction materials (brake pads), with the plurality of depressions, preferably a large number of grooves, being arranged in the brake track. The functionality of the fully cast aluminum-silicon alloy brake disc of a hypereutectic (preferably 16-20 wt. % silicon content) almost copper-free alloy, as the inventors surprisingly found, is achieved only by the combination with a grooved brake track and the mentioned copper-free or copper-containing NAO friction materials, Instead of grooves, provision may also be made for countersunk bores or similar depressions. The depressions, preferably furrows or grooves, in combination with copper-free or copper-containing NAO friction materials not only act hereby as component that increases the coefficient of friction, but also help in the creation of a transfer layer that forms between the friction material and the brake disc. This reduces wear when compared to a “smooth” brake track. The wet braking behavior is also significantly improved. The corrosion resistance of the brake disc is realized as a result of the hypereutectic aluminum-silicon alloy with a copper content of almost “zero”, i.e. maximal 0.3 wt. % of copper. The suitable hardness, strength, even at temperature ranges from 400° C.-500° C., preferably from 400° C.-450° C., is achieved by the high silicon content, with the need for subsequent temperature treatments and/or addition of fibers being eliminated, The primary silicon particle size is small (preferably 30-50 μm), with the distribution of the silicon particles in the hypereutectic aluminum-silicon alloy being homogeneous. Economic viability of the technology is ensured because the system involves a fully cast brake disc. Apart from machining, the brake disc does not require any further treatment in order to function as a brake in the mentioned tribological system. Optional “hard anodizing” or surface oxidation using a laser additionally improves wear behavior of the disc and pad and also the corrosion resistance. To increase strength and improve wear behavior, niobium carbide can also be added to the hypereutectic aluminum-silicon alloy.

What is claimed is:

1.-11. (canceled)

12. A disc brake, comprising:
a brake disc made of light metal and including a brake track having formed therein a plurality of depressions which are distributed over a surface of the brake track, said brake disc being formed from a hypereutectic aluminum silicon alloy, which has a silicon content of 13 to 21 wt. % and a maximum content of 0.3 wt. % of copper; and
a brake pad configured to act on the brake disc and including a NAO friction material.

13. The disc brake of claim 12, wherein the hypereutectic aluminum-silicon alloy includes the following components:
13 to 21 wt. % of silicon,
0.2 to 0.7 wt. % of magnesium,
maximum 0.001 wt. % of strontium,
maximum 0.2 wt. % of iron,
0.06 to 0.1 wt. % of titanium,
maximum 0.3 wt. % of copper, and
remainder aluminum.

14. The disc brake of claim 12, wherein the hypereutectic aluminum-silicon alloy includes the following components:
16 to 20 wt. % of silicon,
0. 2 to 0.7 wt. % of magnesium,
maximum 0.001 wt. % of strontium,
maximum 0.2 wt. % of iron,
0.06 to 0.1 wt. % of titanium,
maximum 0.3 wt. % of copper, and
remainder aluminum.

15. The disc brake of claim 12, wherein the hypereutectic aluminum-silicon ahoy includes silicon particles having a primary silicon particle size of 30 to 100 μm, preferably 30 to 50 μm, further preferably maximal 50 μm.

16. The disc brake of claim 12, wherein the hypereutectic aluminum-silicon alloy includes AlCuP elements at an amount to effect a proportion of 15 to 30 ppm of phosphorus.

17. The disc brake of claim 12, wherein the brake disc is made in one piece, preferably through a cast process.

18. The disc brake of claim 12, wherein the brake disc is made by a low-pressure casting process.

19. The disc brake of claim 18, wherein the low-pressure casting process uses a casting mold which is heated and insulated.

20. The disc brake of claim 18, wherein the brake disc is hard anodized or laser-oxidized after the casting process.

21. The disc brake of claim 12, wherein the NAO friction material is free of asbestos and free of copper or contains copper.

22. A method for producing a disc brake, said method comprising:
producing a hypereutectic aluminum-silicon ahoy containing silicon particles having a primary silicon particle size of 30 to 100 μm, preferably 30 to 50 μm, further preferably maximal 50 μm;
grain refining the primary silicon to effect a proportion of 15 to 30 ppm of phosphorus; and
subjecting the hypereutectic aluminum-silicon alloy to a low-pressure casting process to produce a brake disc with a homogeneous microstructure and low microporosity of the brake disc.

23. The method of claim 22, further comprising:
arranging a brake track on the brake disc; and
forming a plurality of depressions on the brake track.

24. The method of claim 23, further comprising attaching a brake pad for engagement upon the brake track, with the brake pad including a NAO friction material.

25. The method of claim 22, wherein the hypereutectic aluminum-silicon alloy includes a silicon content of 13 to 21 wt. % and a maximum content of 0.3 wt. % of copper.

26. The method of claim 22, wherein the hypereutectic aluminum-silicon alloy includes AlCuP elements at an amount to effect the proportion of 15 to 30 ppm of phosphorus.

27. The method of claim 22, wherein the brake disc is made in one piece.

28. The method of claim 22, wherein the low-pressure casting process uses a casting mold which is heated and insulated.

29. The method of claim 22, further comprising hard anodizing or laser-oxidizing the brake disc after the casting process.

30. The method of claim 24, wherein the NAO friction material is free of asbestos and free of copper or contains copper.
